(19) United States
(12) Patent Application Publication
(10) Pub. No.: US 2014/0198310 A1
(43) Pub. Date: Jul. 17, 2014

(54) Balanced-Detection Spectra Domain Optical Coherence Tomography System

(71) Applicant: NATIONAL YANG-MING UNIVERSITY, Taipei City (TW)

(72) Inventor: Wen-Chuan KUO, Taipei City (TW)

(73) Assignee: NATIONAL YANG-MING UNIVERSITY, Taipei City (TW)

(21) Appl. No.: 13/875,009

(22) Filed: May 1, 2013

(30) Foreign Application Priority Data
Jan. 17, 2013 (TW) 102101752

(51) Int. Cl. G01B 9/02

(52) U.S. Cl. CPC G01B 9/02091
USPC 356/51; 356/451

(57) ABSTRACT

A balanced-detection spectra domain optical coherence tomography system is disclosed. A light beam L emitting from the light source module is passed through the second beam splitter, the first beam splitter in series, and then split to the mirror and the sample respectively, and further simultaneously reflected to the first beam splitter, a light beam L1 and a light beam L2 are refracted by the first beam splitter and the second beam splitter respectively, and then transmitted to the first collimator and the second collimator respectively, and a phase difference between the light beam L1 and the light beam L2 is 180°. Thereby, simple and efficient background noise suppression, including DC noise and the light interferences at each interface of the sample, is provided.

### FIELD OF THE INVENTION

The present invention relates generally to optical coherence tomography, and more specifically to a balanced-detection spectra domain optical coherence tomography system.

### BACKGROUND OF THE INVENTION

Today, optical coherence tomography (OCT), based on low coherence interferometry, has become a powerful tool that can support non-contact high-speed tomography imaging in transparent and turbid specimens. By using this technique, the depth-resolved backscattered light can be measured so that micrometer-resolution images can be captured. The earliest implementation of OCT involved the mechanical scanning of a reference mirror to perform A-scans in the time domain (TD).

In recent years, the Fourier Domain OCD (FD-OCT) system, which can be implemented either with a swept laser source or a spectrometer-based system (SD-OCT), has enabled an improved sensitivity that makes rapid 3D imaging of tissue possible. The standard FD-OCT image contains autocorrelation (AC) artifacts from the spectrum of the light source and the mutual interference of all the elementary waves backscattered from the object. These two items yield the dc and low-frequency noise that obscure the structure of the tissue under study and also result in a relatively low imaging dynamic range. The standard SD-OCT (please refer to patent US2011/0202044A1) also suffers from a strong signal-to-noise ratio (SNR) fall-off, which is proportional to the distance from zero-delay.

### SUMMARY OF THE INVENTION

One objective of this invention is providing a balanced-detection spectra domain optical coherence tomography system, which is providing simple and efficient background noise suppression, including DC noise and the light interferences at each interface of the sample.

To achieve above objective, a balanced-detection spectra domain optical coherence tomography system is provided and comprises a first beam splitter, a second beam splitter, a first collimator, a second collimator, an objective lens, a light source module, a spectrometer, a fiber, an aperture, and a mirror, wherein one end of the objective lens in axial direction is arranged adjacent to a sample; the first beam splitter is arranged adjacent to the other end of the objective lens in axial direction which is distant from the sample; the second beam splitter is arranged adjacent to one end of the first beam splitter which is distant from the objective lens; the first collimator is arranged one side of the first beam splitter in lateral direction; the second collimator is arranged one side of the second beam splitter in lateral direction; the light source module is arranged adjacent to one end of the second beam splitter which is distant from the first beam splitter; one end of the fiber is connected with the first collimator and the second collimator, the other end of the fiber is connected to one end of the spectrometer via the aperture, and the other end of the spectrometer is connected to a processing unit; and the mirror is arranged at one side of the first beam splitter in lateral direction which is distant from the first collimator; wherein a light beam L emitting from the light source module is passed through the second beam splitter, the first beam splitter in series, and then split to the mirror and the sample respectively, and further simultaneously reflected to the first beam splitter, a light beam L1 and a light beam L2 are refracted by the first beam splitter and the second beam splitter respectively, and then transmitted to the first collimator and the second collimator respectively, and a phase difference between the light beam L1 and the light beam L2 is 180°.

In some embodiment, the first beam splitter is a non-polarizing beam splitter.

In some embodiment, the light source module is a superluminescent LED for providing a light having a 830 nm wavelength and a 26 nm full-width-at-half-maximum.

In some embodiment, the spectrometer is a multi-channel spectrometer or a spectrometer with at least two single channels.

In some embodiment, an interference signal I₁ of the first collimator in k-space is expressed as:

$${I}_{1} = {\vert {E}_{r} ( k ) + {\int }_{- ∞}^{∞} a ( z ) {e}^{- i ( 2 knz + \frac{π}{2} )} d z \vert}^{2} ;$$

wherein Eᵣ is the amplitude of a reference light, n is the refractive index of the sample, and a(z) is the amplitudes of backscattering from the sample at depth z.

In some embodiment, an interference signal I₂ of the second collimator in k-space is expressed as:

$${I}_{2} = {\vert {E}_{r} ( k ) {e}^{- i \frac{π}{2}} + {\int }_{- ∞}^{∞} a ( z ) {e}^{- i 2 knz} d z \vert}^{2} ,$$

In some embodiment, the light source module comprises two light sources for providing a light with different wavebands or a single light source for providing a light with two different wavebands.

To achieve above objective, a balanced-detection spectra domain optical coherence tomography system is further provided and comprises an optical fiber coupler, an optical fiber circulator, an optical fiber collimator, a light source module, a sample, a spectrometer, and a fiber mirror, wherein the light source module is connected with the optical fiber circulator, the optical fiber circulator is connected with the optical fiber coupler and the spectrometer, the optical fiber coupler is connected with the optical fiber collimator and the fiber mirror, the optical fiber collimator is aimed at the sample, and the other end of the spectrometer is connected with a processing unit; and wherein a light beam L′ emitted from the light source module is passed through the optical fiber circulator and the optical fiber coupler in series, and then a light beam L1′ and a light beam L2′ are transmitted to the fiber mirror and to the sample via the optical fiber collimator respectively, and further the light beam L1′ and the light beam L2′ are simultaneously reflected to the optical fiber coupler and then outputted via the optical fiber coupler and the optical fiber circulator, and further transmitted to the spectrometer, and a phase difference between the light beam L1′ and the light beam L2′ is 180°.

### BRIEF DESCRIPTION OF THE DRAWINGS

FIG. 1(a) is a schematic drawing showing a first embodiment of the balanced-detection spectra domain optical coherence tomography system in accordance with this invention.

FIG. 1(b) is a schematic drawing showing a second embodiment of the balanced-detection spectra domain optical coherence tomography system in accordance with this invention.

FIG. 2 is a waveform diagram showing each fiber's dispersed spectrum projected onto different lines of a 2D CCD (2048×512 pixels, pixel size is 12×12 μm) by using a commercial available multi-channel spectrometer (HISPPEC VIR-0.5, P&P Optica Inc.) and using two fiber inputs (core distance is 500 μm).

FIGS. 3(a) and 3(b) are waveform diagrams showing the result after pixel binning in separate regions of a 2D CCD in FIG. 2 representing the two channels connected to the first collimator and the second collimator respectively.

FIG. 3(c) is a waveform diagram showing an apparent π phase shift between two simultaneously obtained interferograms of FIGS. 3(a) and 3(b).

FIG. 3(d) is a waveform diagram showing the result of subtracting the signal (I₁ and I₂) of the first collimator and the second collimator.

FIG. 4(a) is a waveform showing the depth-dependent decay (linear scale) obtained from a mirror surface with attenuated sample arm power by means of neutral density filter in different detection scheme.

FIG. 4(b) is an enlarged view showing log scale demonstrated 109.6 dB of SNR and measured for the peak at 0.2 mm by using BD dual-detection scheme.

FIG. 5(a) is a schematic diagram showing the sample arm and object.

FIG. 5(b) is a B-scan OCT image taken by a conventional single detection SD-OCT.

FIG. 5(C) is an image showing partial dc offset and autocorrelation noise (AC) with background subtraction.

FIG. 5(d) is an image showing the result from the BD SD-OCT method of this invention that the autocorrelation noise including the dc and AC form is largely suppressed.

FIG. 5(e) is a curve diagram showing the comparison of the single Ascan depth profile (linear scale) in FIGs. (b) to (d).

### DETAILED DESCRIPTION OF THE INVENTION

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, when a number or a range is recited, ordinary skill, in the art understand it intends to encompass an appropriate, reasonable range for the particular field related to the invention.

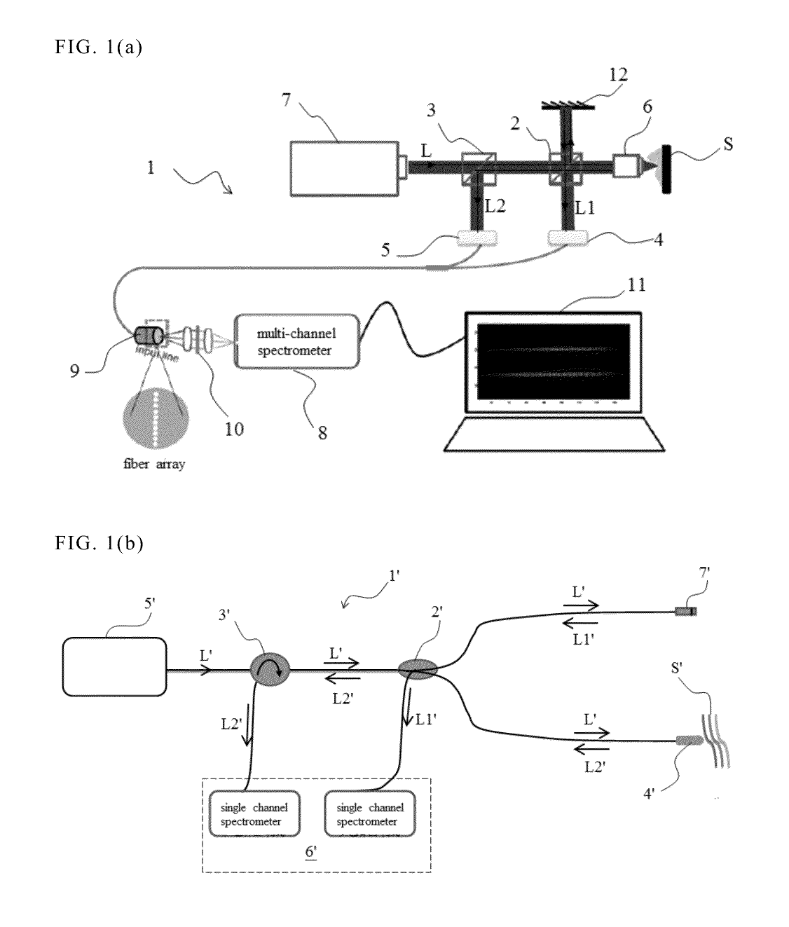

FIG. 1(a) is a schematic drawing showing a first embodiment of the balanced-detection spectra domain optical coherence tomography system in accordance with this invention.

Please reference to FIG. 1(a), the balanced-detection spectra domain optical coherence tomography system 1 of this embodiment comprises a first beam splitter 2, a second beam splitter 3, a first collimator 4, a second collimator 5, an objective lens 6, a light source module 7, a spectrometer 8, a fiber 9, an aperture 10, a personal computer 11, and a mirror 12.

One end of the objective lens 6 in axial direction may be arranged adjacent to a sample S.

The first beam splitter 2 may be arranged adjacent to the other end of the objective lens 6 in axial direction which is distant from the sample S, and the first beam splitter 2 may be a non-polarizing beam splitter.

The second beam splitter 3 is arranged adjacent to one end of the first beam splitter 2 which is distant from the objective lens 6.

The first collimator 4 may be arranged one side of the first beam splitter 2 in lateral direction.

The second collimator 5 is arranged one side of the second beam splitter 3 in lateral direction.

The mirror 12 may be arranged at one side of the first beam splitter 2 in lateral direction which is distant from the first collimator 4.

The light source module 7 may be arranged adjacent to one end of the second beam splitter 3 which is distant from the first beam splitter 2, and the light source module 7 may be a superluminescent LED (SLD) for providing a light having an 830 nm wavelength and a 26 nm full-width-at-half-maximum.

Furthermore, the light source module 7 may comprise two light sources for providing a light with different wavebands or a single light source for providing a light with two different wavebands. For example, two SLD may be providing two signals of two light sources which include the center wavelengths 800 nm and 1300 nm respectively and the bandwidth in the range of 100 nm for each, and is received by two corresponding spectrometers; or, a white-light source (or supercontinuum laser) includes two wavebands (such as the center wavelengths is 800 nm and 1300 nm respectively and the bandwidth is in the range of 100 nm for each), a light beam L1 is filtered by one optical filter which only the light beam with an 800 nm center wavelength and a 100 nm bandwidth can be passed through and then transmitted to one spectrometer, and a light beam L2 is filtered by another optical filter which only the light beam with a 1300 nm center wavelength can be passed through, and then transmitted to another spectrometer.

One end of the fiber 9 is connected with the first collimator 4 and the second collimator 5, the other end of the fiber 9 is connected to one end of the spectrometer 8 via the aperture 10, and the other end of the spectrometer 8 is connected to a processing unit, such as a personal computer 11.

The light beam L emitting from the light source module 7 is passed through the second beam splitter 3, the first beam splitter 2 in series, and then split to the mirror 12 and the sample S respectively, and further simultaneously reflected to the first beam splitter 2, the light beam L1 and the light beam L2 are refracted by the first beam splitter 2 and the second beam splitter 3 respectively, and then transmitted to the first collimator 4 and the second collimator 5 respectively, and a phase difference between the light beam L1 and the light beam L2 is 180°.

The signals of the light beams L1 and L2 respectively received by the first collimator 4 and the second collimator 5 are passed through the fiber 9 and aperture 10 in series and then transmitted to the spectrometer 8 for spectrum measurement, and further transmitted to the processing unit, such as the personal computer 11, for analysis.

The spectrometer 8 may be a multi-channel spectrometer (shown as in FIG. 1(a)) or a spectrometer unit with at least two single channels (shown as in FIG. 1(b)), but it is not limited thereto.

The interference signal I₁ of the first collimator 4 in k-space is expressed as:

$$\begin{matrix}{I}_{1} = {\vert {E}_{r} ( k ) + {\int }_{- ∞}^{∞} a ( z ) {e}^{- i ( 2 knz + \frac{π}{2} )} d z \vert}^{2} \\ = {E}_{r}^{2} ( k ) + {\int }_{- ∞}^{∞} {\int }_{- ∞}^{∞} a ( z ) a ( {z}^{′} ) cos [ 2 kn ( z - {z}^{′} ) ] d z d {z}^{′} + \\ 2 {E}_{r} {\int }_{- ∞}^{∞} a ( z ) cos ( 2 knz + \frac{π}{2} ) d z\end{matrix} \qquad eq . ( 1 )$$

wherein Eᵣ is the amplitude of a reference light, n is the refractive index of the sample S, and a(z) and a(z′) are the amplitudes of backscattering from the sample S at depth z and z′ respectively.

The interference signal I2 of the second collimator 5 in k-space is expressed as:

$$\begin{matrix}{I}_{1} = {\vert {E}_{r} ( k ) + {\int }_{- ∞}^{∞} a ( z ) {e}^{- i ( 2 knz + \frac{π}{2} )} d z \vert}^{2} \\ = {E}_{r}^{2} ( k ) + {\int }_{- ∞}^{∞} {\int }_{- ∞}^{∞} a ( z ) a ( {z}^{′} ) cos [ 2 kn ( z - {z}^{′} ) ] d z d {z}^{′} + \\ 2 {E}_{r} {\int }_{- ∞}^{∞} a ( z ) cos ( 2 knz + \frac{π}{2} ) d z \\ = {E}_{r}^{2} ( k ) + {\int }_{- ∞}^{∞} {\int }_{- ∞}^{∞} a ( z ) a ( {z}^{′} ) cos [ 2 kn ( z - {z}^{′} ) ] d z d {z}^{′} - \\ 2 {E}_{r} {\int }_{- ∞}^{∞} a ( z ) cos ( 2 knz + \frac{π}{2} ) d z\end{matrix} \qquad eq . ( 2 )$$

The first two terms in eq. (1) and eq. (2) consist of a constant dc offset Eᵣ², which is the autocorrelation of the light spectrum, and the mutual interference of all elementary waves backscattered from the sample S. Taken separately, eq. (1) and eq. (2) represent the output signals from the conventional single detection scheme for two channels, respectively. Besides, the first two terms in eq. (1) and eq. (2) yield the do and low-frequency noise that obscure the structure of the tissue.

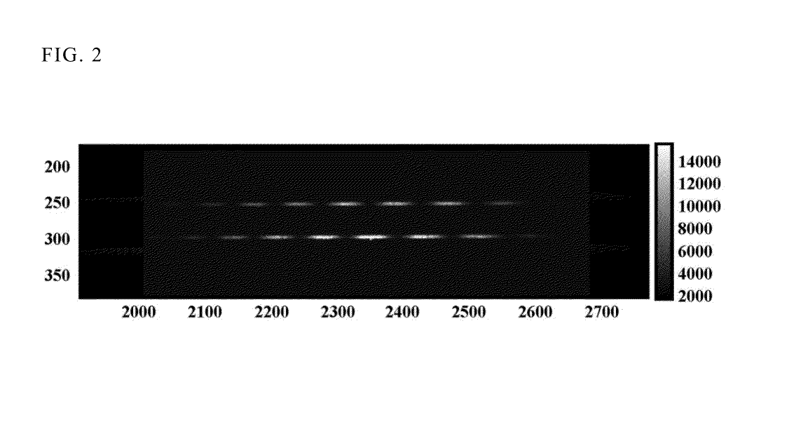

To solve these problems, the embodiment is using a commercial available multi-channel spectrometer (HISPPEC VIR-0.5, P&P Optica Inc.). This high performance multi-channel spectrometer based on a gel grating that can be used as a robust, low cost replacement of multiple spectrometers. The unique transmission design with carefully aberration compensation allows for monitoring of up to 200 separate channels all in a single exposure. In this embodiment, two fiber (core distance is 500 μm) is used for input, and each fiber's dispersed spectrum is projected onto different lines of a 2D CCD (2048×512 pixels, pixel size is 12×12 μm)(shown as in FIG. 2).

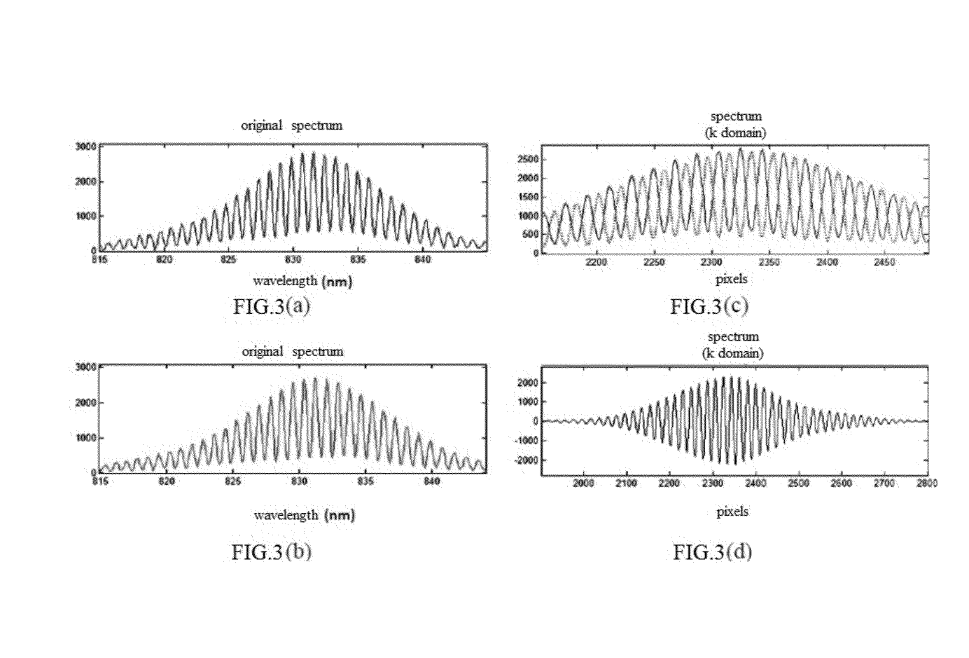

The resulting image is shown as in FIG. 2. The results after pixel binning in separate regions representing two channels are shown as in FIGS. 3(a) and 3(b), respectively. It can be seen that there is an apparent π phase shift between the signals of the first collimator 4 and the second collimator 5, as demonstrated in the enlarged picture in FIG. 3(c), and then the result of subtracting I2 from I1 is shown as in FIG. 3(d).

Both first and second terms in eq. (1) and eq. (2) cancel each other, so the output after subtraction is:

$${I}_{diff} ( k ) = 4 {E}_{r} {\int }_{- ∞}^{∞} a ( z ) cos ( 2 knz + \frac{π}{2} ) d z \qquad eq . ( 3 )$$

The signal current in eq. (3) is indeed double that of the single detection signal given by eq. (1) or eq. (2). Then the depth information of the sample S can be obtained by a Fourier transform of eq. (3) from k-space (frequency domain) to z-space (time domain).

Spectral density fluctuations of the laser may still cause I_{diff} of eq. (3) to fluctuate, but the magnitude is proportional to a(z)Eᵣ. Normally, the sample backscattering, a(z), is much weaker than Eᵣ, so that the output signal is practically free from the noise generated by the intensity fluctuations of the light source (such as laser).

The embodiment is initially used a mirror (single interface) as a sample, to simulate different depths of the sample signal. SNR in dB is calculated by adding the fiber's damping to the determined difference of A-scan peak to noise baseline.

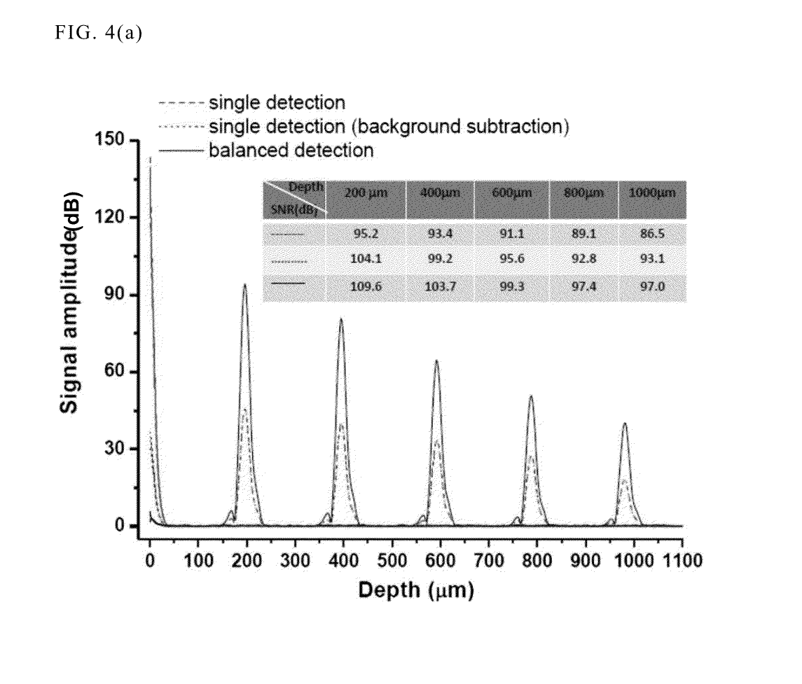

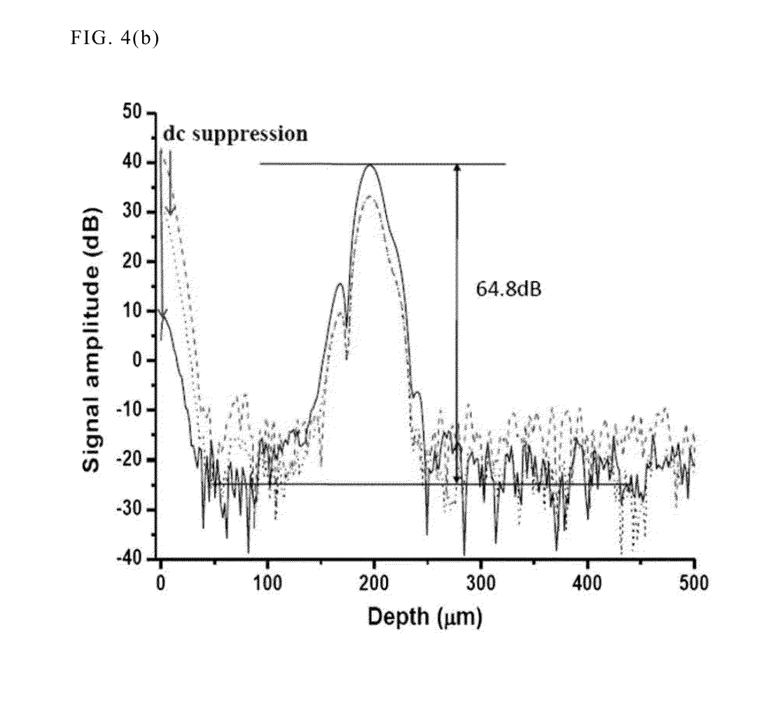

FIG. 4(a) shows the depth-dependent decay (linear scale) obtained from a mirror surface with attenuated sample arm power by means of neutral density filters in different detection scheme. Compared to conventional single detection SD-OCT (dashed curve) or single detection with background subtraction (dotted curve), the BD SD-OCT of this embodiment (solid curve) shows large dc suppression and signal enhancement. With 13.5 μW incident on the sample and a calibrated 44.8 dB of sample arm attenuation, single detection with background subtraction gives an SNR improvement of 3˜8 dB for the peak within 1 mm. However, the BD SD-OCT in this embodiment has resulted in 8˜14 dB improvement of the SNR for the peak within 1 mm compared to conventional single detection method.

The enlarged picture in FIG. 4(b) using log scale demonstrated 109.6 dB of SNR is measured for the peak at 0.2 mm by using BD dual-detection scheme. Moreover, compared to conventional single detection SD-OCT, the background subtraction method used in this embodiment provides a dc suppression of 10 dB while the BD SD-OCT of this embodiment gives a dc suppression of 35 dB.

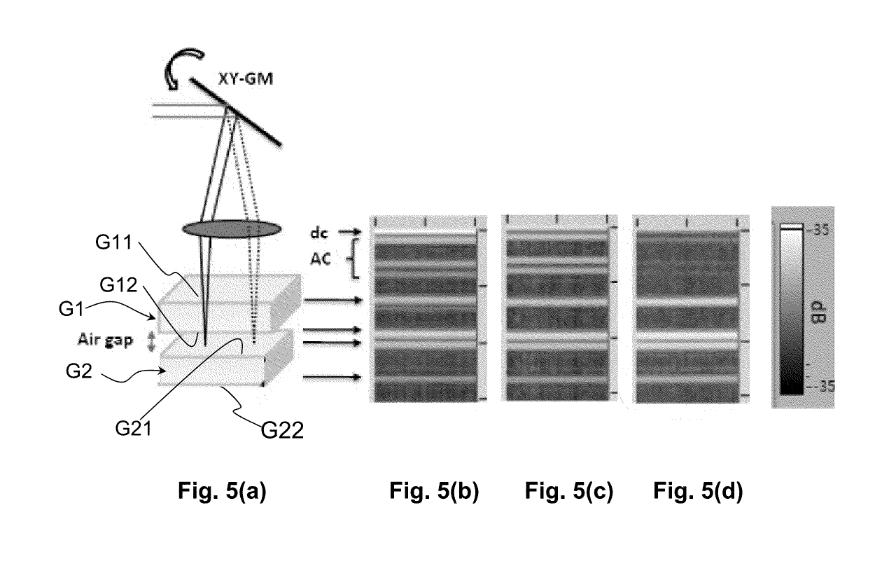

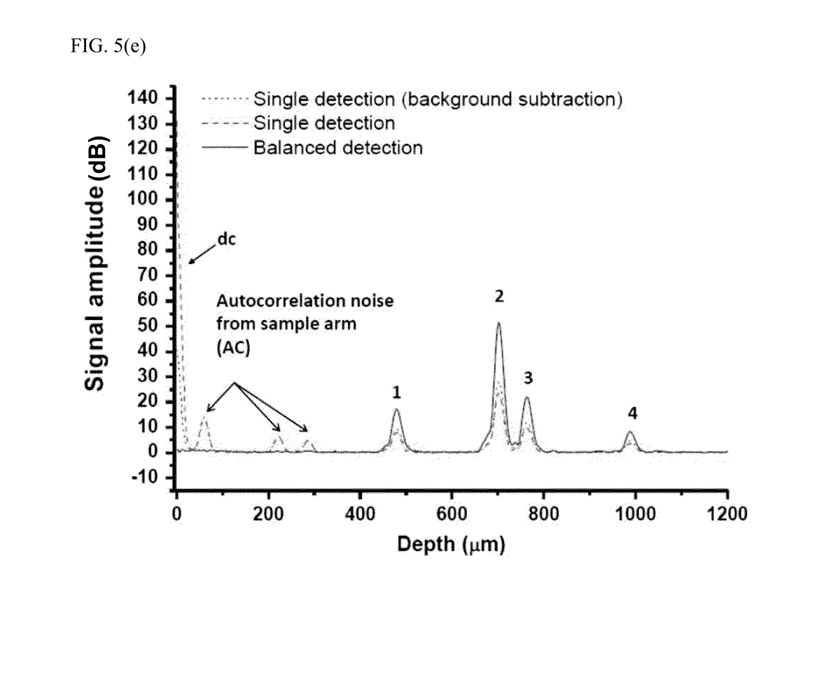

Then, two cover glasses, with thickness of approximately 200 μm, separated by an air gap is used as a multilayer sample (four interfaces) to demonstrate the autocorrelation term removal ability. FIG. 5(a) shows a schematic diagram of the sample arm and object. Here, the front surface and back surface of the first glass slide G1 are indicated by G11 and G12, respectively; and the front surface and back surface of the second glass slide G2 are indicated by G21 and G22, respectively. B-scan OCT images taken by conventional single detection SD-OCT is shown in FIG. 5(b).

With background subtraction, partial dc offset and autocorrelation noise (AC) is still present as shown in FIG. 5(c). FIG. 5(d) shows the result from the BD SD-OCT method of this embodiment: the autocorrelation noise, including the dc and AC term, is largely suppressed. FIG. 5(e) compares single A-scan depth profile (linear scale) in FIGS. 5(b) to 5(d). This data shows that the method of this embodiment comparing to background subtraction method provides more efficient suppression of the background features, including the dc noise and mutual interference between each surface of the glass plate (AC noise).

FIG. 1(b) is a schematic drawing showing a second embodiment of the balanced-detection spectra domain optical coherence tomography system in accordance with this invention.

Please reference to FIG. 1(b), a balanced-detection spectra domain optical coherence tomography system 1′ of this embodiment comprises an optical fiber coupler 2′, an optical fiber circulator 3′, an optical fiber collimator 4′, a light source module 5′, a sample S′, a spectrometer 6′, and a fiber mirror 7′.

The light source module 5′ is connected with the optical fiber coupler 3′, the optical fiber coupler 3′ is connected with the optical fiber circulator 2′ and the spectrometer 6′, the optical fiber circulator 2′ is connected with the optical fiber collimator 4′ and the fiber mirror 7′, the optical fiber collimator 4′ is aimed at the sample S′, and the other end of the spectrometer 6′ is connected with a processing unit (the personal computer 11, shown as in FIG. 1(a)).

The light source module 5′ may be a wideband light source module. A light beam L′ emitted from the light source module 5′ is passed through the optical fiber circulator 3′ and the optical fiber coupler 2′ in series, and then a light beam L1′ and a light beam L2′ are transmitted to the fiber mirror 7′ and to the sample S′ via the optical fiber collimator 4′ respectively, and further the light beam L1′ and the light beam L2′ are simultaneously reflected to the optical fiber coupler 2′ and then outputted via the optical fiber coupler 2′ and the optical fiber circulator 3′, and further transmitted to the spectrometer unit 6′, and a phase difference between the light beam L1′ and the light beam L2′ is 180°.

The light source module 5′ may comprise two light sources for providing a light with different wavebands or a single light source for providing a light with two different wavebands. For example, two SLD may be providing two signals of two light sources which include the center wavelengths 800 nm and 1300 nm respectively and the bandwidth in the range of 100 nm for each, and is received by two corresponding spectrometers; or, a white-light source (or supercontinuum laser) includes two wavebands (such as the center wavelengths is 800 nm and 1300 nm respectively and the bandwidth is in the range of 100 nm for each), a light beam L1′ is filtered by one optical filter which only the light beam with an 800 nm center wavelength and a 100 nm bandwidth can be passed through and then transmitted to one spectrometer, and a light beam L2′ is filtered by another optical filter which only the light beam with a 1300 nm center wavelength can be passed through, and then transmitted to another spectrometer.

The spectrometer 6′ may be a multi-channel spectrometer (shown as in FIG. 1(a)) or a spectrometer unit with at least two single channels (shown as in FIG. 1(b)), but it is not limited thereto.

The effects of this embodiment can be achieved the same as the first embodiment, so the detail description is omitted.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments and examples were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

What is claimed is:

1. A balanced-detection spectra domain optical coherence tomography system, comprising a first beam splitter, a second beam splitter, a first collimator, a second collimator, an objective lens, a light source module, a spectrometer, a fiber, an aperture, and a mirror, wherein:
one end of the objective lens in axial direction is arranged adjacent to a sample;
the first beam splitter is arranged adjacent to the other end of the objective lens in axial direction which is distant from the sample;
the second beam splitter is arranged adjacent to one end of the first beam splitter which is distant from the objective lens;
the first collimator is arranged one side of the first beam splitter in lateral direction;
the second collimator is arranged one side of the second beam splitter in lateral direction;
the light source module is arranged adjacent to one end of the second beam splitter which is distant from the first beam splitter;
one end of the fiber is connected with the first collimator and the second collimator, the other end of the fiber is connected to one end of the spectrometer via the aperture, and the other end of the spectrometer is connected to a processing unit; and
the mirror is arranged at one side of the first beam splitter in lateral direction which is distant from the first collimator;
wherein a light beam L emitting from the light source module is passed through the second beam splitter, the first beam splitter in series, and then split to the mirror and the sample respectively, and further simultaneously reflected to the first beam splitter, a light beam L1 and a light beam L2 are refracted by the first beam splitter and the second beam splitter respectively, and then transmitted to the first collimator and the second collimator respectively, and a phase difference between the light beam L1 and the light beam L2 is 180°.

2. The system as claimed in claim 1, wherein, the first beam splitter is a non-polarizing beam splitter.

3. The system as claimed in claim 1, wherein, the light source module is a superluminescent LED for providing a light having a 830 nm wavelength and a 26 nm full-width-at-half-maximum.

4. The system as claimed in claim 1, wherein, the spectrometer is a multi-channel spectrometer or a spectrometer unit with at least two single channels.

5. The system as claimed in claim 1, wherein, an interference signal I₁ of the first collimator in k-space is expressed as:
$${I}_{1} = {\vert {E}_{r} ( k ) + {\int }_{- ∞}^{∞} a ( z ) {e}^{- i ( 2 knz + \frac{π}{2} )} d z \vert}^{2} ;$$
wherein Eᵣ is the amplitude of a reference light, n is the refractive index of the sample, and a(z) is the amplitudes of backscattering from the sample at depth z.

6. The system as claimed in claim 5, wherein, an interference signal I₂ of the second collimator in k-space is expressed as:
$${I}_{2} = {\vert {E}_{r} ( k ) {e}^{- i \frac{π}{2}} + {\int }_{- ∞}^{∞} a ( z ) {e}^{- i 2 knz} d z \vert}^{2} .$$

7. The system as claimed in claim 1, wherein, the light source module comprises two light sources for providing a light with different wavebands or a single light source for providing a light with two different wavebands.

8. A balanced-detection spectra domain optical coherence tomography system, comprising an optical fiber coupler, an optical fiber circulator, an optical fiber collimator, a light source module, a sample, a spectrometer, and a fiber mirror, wherein:
the light source module is connected with the optical fiber circulator, the optical fiber circulator is connected with the optical fiber coupler and the spectrometer, the optical fiber coupler is connected with the optical fiber collimator and the fiber mirror, the optical fiber collimator is aimed at the sample, and the other end of the spectrometer is connected with a processing unit; and
wherein a light beam L′ emitted from the light source module is passed through the optical fiber circulator and the optical fiber coupler in series, and then a light beam L1′ and a light beam L2′ are transmitted to the fiber mirror and to the sample via the optical fiber collimator respectively, and further the light beam L1′ and the light beam L2′ are simultaneously reflected to the optical fiber coupler and then outputted via the optical fiber coupler and the optical fiber circulator, and further transmitted to the spectrometer, and a phase difference between the light beam L1′ and the light beam L2′ is 180°.

9. The system as claimed in claim 8, wherein, the light source module is a superluminescent LED for providing a light having a 830 nm wavelength and a 26 nm full-width-at-half-maximum.

10. The system as claimed in claim 8, wherein, the spectrometer is a multichannel spectrometer or a spectrometer with at least two single channels.

11. The system as claimed in claim 8, wherein, an interference signal I₁ of the light beam L1′ and an interference signal I₂ of the light beam L2′ in k-space are expressed as:
$${I}_{1} = {\vert {E}_{r} ( k ) + {\int }_{- ∞}^{∞} a ( z ) {e}^{- i ( 2 knz + \frac{π}{2} )} d z \vert}^{2} , \\ {I}_{2} = {\vert {E}_{r} ( k ) {e}^{- i \frac{π}{2}} + {\int }_{- ∞}^{∞} a ( z ) {e}^{- i2 knz} d z \vert}^{2} ;$$
wherein Eᵣ is the amplitude of a reference light, n is the refractive index of the sample, and a(z) and a(z′) are the amplitudes of backscattering from the sample at depth z and z′ respectively.

12. The system as claimed in claim 8, wherein, the light source module comprises two light sources for providing a light with different wavebands or a single light source for providing a light with two different wavebands.
